(19) United States
(12) Patent Application Publication
(10) Pub. No.: US 2010/0136837 A1
(43) Pub. Date: Jun. 3, 2010

(54) ELECTRICAL CONNECTOR WITH ENHANCED CONTACT PRESSURE

(75) Inventor: Ulrik MADSEN, Holstebro (DK)

Correspondence Address: CANTOR COLBURN, LLP, 20 Church Street, 22nd Floor, Hartford, CT, 06103, US

(73) Assignee: HPAG HOLDING APS, Silkeborg (DK)

(21) Appl. No.: 12/627,110

(22) Filed: Nov. 30, 2009

(30) Foreign Application Priority Data
Nov. 28, 2008 (DK) PA 2008 01678

(51) Int. Cl. H01R 13/46

(52) U.S. Cl. 439/625

(57) ABSTRACT

An electrical connector is disclosed comprising a female contact member and at least one resilient contact pressure enhancing member, wherein at least a part of the female contact member is formed as a substantially cylindrical shell having at least one slit extending in a longitudinal direction from an open end of the cylindrical shell at least a part of the way to the other end of the cylindrical shell, the at least one contact pressure enhancing member is arranged to apply an inward pressure to at least a part of an outer surface of the cylindrical shell, the at least one contact pressure enhancing member applies pressure to the outer surface of the shell from substantially all radial directions, and the at least one contact pressure enhancing member is an O-ring.

The present invention relates to the field of electrical connectors.

### BACKGROUND

Ideally, to get the optimum electrical connections through an electrical connector, the conducting parts of the connector should be made from materials of the highest conductivity, such as pure annealed silver, copper or gold, which are all soft metals.

Contrary to brass and other hard alloys, such soft metals show no or almost no elasticity. This means that the contact pressures of electrical connectors made from such materials will decrease significantly already after a few times of connection and disconnection of the connectors. In severe cases, the contact pressure might be completely lost, which again might lead to damaging or even destruction of one or more of the connected apparatuses.

For that reason, alloys with a higher elasticity, such as brass or bronze are used as contact materials in most of the available connectors, which, in most cases, is a fine solution to the problem of maintaining the contact pressure after repeated connection and disconnection of the connector.

However, both brass and bronze have a significantly lower conductivity than silver, copper or gold, and connectors using such alloys as contact materials will have lower conductivity than connectors having contacts made from pure silver, copper or gold. In some applications, this fact can be of significant importance.

One way of improving the contact pressure of a female connector is disclosed in US Patent Application No. US 2008/0242151 A1, wherein a clamping shell is clamped on the periphery of a tubular contact portion of a female connector terminal. The clamping shell is a custom-made and integrated part of the connector. The prior art description of the application further describes how similar clamping shells of a simpler design tend to lose some of their clamping force during use of the connector.

An objective of the present invention is to provide a method for achieving and maintaining sufficient contact pressures in connectors with contacts made from soft metals, such as pure, annealed silver, copper or gold having no or only a very poor natural elasticity, at the same time allowing the contact pressure to be changed from one value to another in a simple and flexible way.

### BRIEF DESCRIPTION OF THE INVENTION

The present invention relates to an electrical connector comprising a female contact member and at least one resilient contact pressure enhancing member, wherein at least a part of the female contact member is formed as a substantially cylindrical shell having at least one slit extending in a longitudinal direction from an open end of the cylindrical shell at least a part of the way to the other end of the cylindrical shell, the at least one contact pressure enhancing member is arranged to apply an inward pressure to at least a part of an outer surface of the cylindrical shell, the at least one contact pressure enhancing member applies pressure to the outer surface of the shell from substantially all radial directions, and the at least one contact pressure enhancing member is an O-ring.

By arranging at least one resilient contact pressure enhancing member to apply an inward pressure to the outer surface of a female contact member, an enhancement of the contact pressure of the female contact member is obtained when the female contact member is in engagement with a corresponding male contact member. Furthermore, the contact pressure enhancing member will assure that the female contact member returns to its original shape and size, when it is removed from the corresponding male contact member. This enables for the use of soft metals, such as silver, copper and gold, as contact materials, thus enhancing the conductivity of the electrical connector.

By using the word “resilient” is meant that the contact pressure enhancing member may be moved in an outward direction (i.e. away from the centre of the female contact member) when the latter expands when being put into engagement with a corresponding male contact member, but tends to move back to its original position as soon as the outward pressure from the male contact member disappears.

Applying pressure to the female contact member from substantially all radial directions is advantageous in that it gives a uniform contact pressure on all sides of the female contact member.

Using an ordinary O-ring as the contact pressure enhancing member is advantageous in that it makes the assembly of the connector very simple. Furthermore, such O-rings are available in basically all sizes and many different plastic or rubber materials, which means that the contact pressure can be changed by simply replacing the O-ring with another one having another size and/or being made from another material having another shore hardness. Thus, different connectors can be adapted to different desired contact pressures using the same special manufactured parts, such as the female contact member and a possible shell surrounding it.

In an embodiment of the invention, the cylindrical shell further comprises one or more transverse slits extending from one or both sides of the at least one slit extending in a longitudinal direction, each of the one or more transverse slits being perpendicular to the slit extending in a longitudinal direction from which it extends.

The use of transverse slits divides at least a part of the female contact member into a number of elements. If one or more pressure enhancing member is placed around each of these elements, a more constant contact pressure is obtained along a substantial length of the female contact member, the female contact member being equally flexible over a substantial length. Furthermore, the higher number of pressure enhancing members will increase the overall contact pressure of the female contact member.

In an embodiment of the invention, part of the cylindrical shell comprises a groove, the dimensions of which are arranged to fit the dimensions of the at least one contact pressure enhancing member so as to keep the at least one contact pressure enhancing member in a substantially fixed position compared to the female contact member.

Keeping the contact pressure enhancing member in a substantially fixed position compared to the female contact member is advantageous in that, in most embodiments, the resulting contact pressure depends on the position of the contact pressure enhancing member. Furthermore, it is avoided that the contact pressure enhancing member falls off the female contact member.

In a preferred embodiment of the invention, the female contact member is made from a soft metal of high conductivity and low elasticity, such as silver, copper or gold.

Using a metal of high conductivity as contact material enhances the conductivity of the electrical connector as a whole and, thus, the signal quality, which is of great importance if, for instance, the electrical connector is used in a high-quality audio application.

In a preferred embodiment of the invention, the electrical connector further comprises an outer shell surrounding at least a part of the cylindrical shell.

Arranging an outer shell around the female contact member enables for a simple and safe electrical insulation between the female contact member and other contact members or the surroundings.

In an embodiment, the female contact member is held in position by at least two contact pressure enhancing members and otherwise substantially surrounded by air.

Such an embodiment enables for the production of an electrical connector using air as the primary dielectric and, thus, reducing the dielectric absorption, for instance by fixating the female contact member by means of contact pressure enhancing members at both ends and a pin or a screw to fix the female contact member in the longitudinal direction.

In a preferred embodiment of the invention, the outer shell comprises a groove, the dimensions of which are arranged to fit the dimensions of the at least one contact pressure enhancing member so as to keep the at least one contact pressure enhancing member in a substantially fixed position compared to the outer shell.

Keeping the contact pressure enhancing member in a substantially fixed position compared to the outer shell is advantageous in that, in most embodiments, the resulting contact pressure depends on the longitudinal position of the contact pressure enhancing member. Furthermore, it is avoided that the contact pressure enhancing member falls off the electrical connector.

In an embodiment of the invention, the outer shell is made from a hard material, such as aluminium, brass or plastic.

Making the outer shell from a hard material facilitates the manufacturing process and protects the female contact member from mechanical impacts from the outside.

In an aspect of the invention, it relates to a method for enhancing the contact pressure of a female contact member of an electrical connector, said method comprising the step of arranging at least one contact pressure enhancing member to apply an inward pressure to at least a part of the outer surface of the female contact member, thus pressing at least a part of the female contact member towards the centre of the female contact member, wherein the at least one contact pressure enhancing member is an O-ring.

By arranging at least one resilient contact pressure enhancing member, such as an O-ring, to apply an inward pressure to at least a part of the outer surface of a female contact member, an enhancement of the contact pressure of the female contact member is obtained when the female contact member is in engagement with a corresponding male contact member. Furthermore, the contact pressure enhancing member will assure that the female contact member returns to its original shape and size when it is removed from the corresponding male contact member. This enables for the use of soft metals, such as silver, copper and gold, as contact materials, thus enhancing the conductivity of the electrical connector.

Using an ordinary O-ring as the contact pressure enhancing, the contact pressure can be changed by simply replacing the O-ring with another one having another size and/or being made from another material having another shore hardness.

### BRIEF DESCRIPTION OF THE FIGURES

In the following, a few embodiments of the invention will be described in further detail with reference to the figures, in which

FIG. 1a illustrates a female contact member as known from the art,

FIG. 1b illustrates a cross-sectional view along the line A-A of the female contact member shown in FIG. 1a,

FIG. 2 illustrates a cross-sectional view of a preferred embodiment of the invention,

FIG. 3 illustrates a cross-sectional view of another embodiment of the invention,

FIG. 4a illustrates a side view of another embodiment of a female contact member according to the invention,

FIG. 4b illustrates an end view of the same embodiment of a female contact member, and

FIG. 4c illustrates a perspective view of the same embodiment of a female contact member.

### DETAILED DESCRIPTION

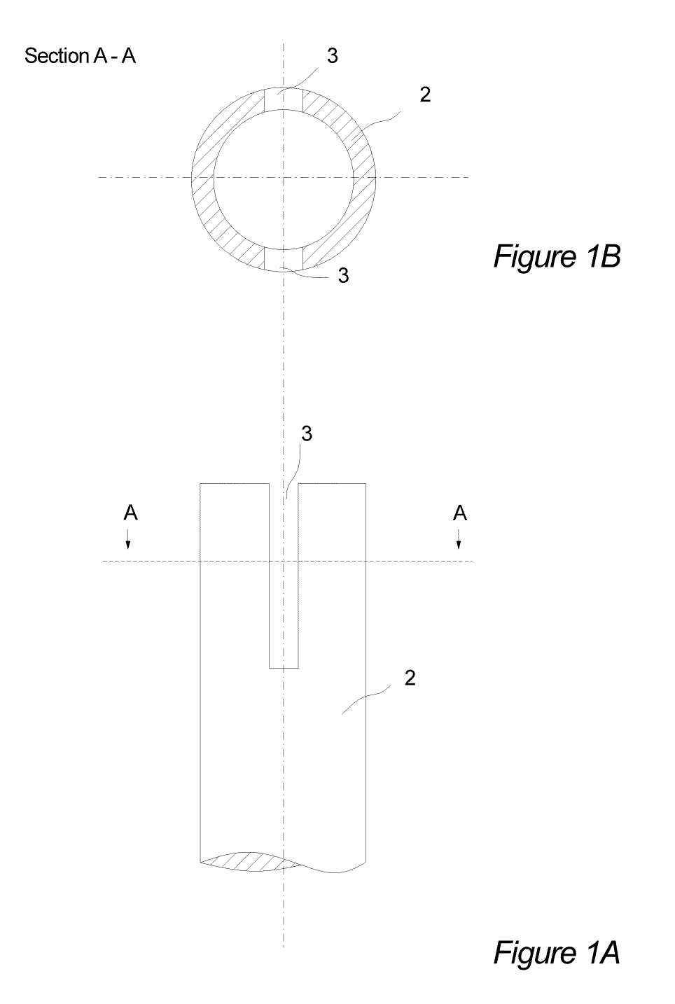

FIGS. 1a and 1b illustrate a female contact member 2 as is well-known from the art. The part of the contact member 2, which is shown in FIG. 1a, is basically shaped like a cylindrical shell, in which two oppositely placed slits 3 extend in a longitudinal direction from an open end of the cylindrical shell at least a part of the way to the other end of the cylindrical shell. The positions of the slits 3 are illustrated in FIG. 1b, which is a cross-sectional view along the line A-A of the female contact member 2 shown in FIG. 1a.

The purpose of the slits 3 is to make the female contact member 2 more flexible, so that a male contact member (not shown) inserted into the end of the female contact member 2, from which the slits 3 extend, will be able to press apart the two halves of the cylindrical shell separated by the two slits 3.

Normally, as is known from the art, the female contact member 2 will be made from a hard metal, and the inherent elasticity of the metal will ensure a sufficient contact pressure between the male and the female contact members 2 when connected. When the male contact member is disconnected from the female contact member 2 again, the elasticity of the metal will bring back the two halves of the cylindrical shell to their original position.

As will be described below, however, the present invention also enables for making the female contact member 2 from softer metals, the inherent elasticities of which are too small to ensure a sufficient contact pressure and to bring back the two halves of the cylindrical shell to their original positions after disconnection of the male and female contact members 2.

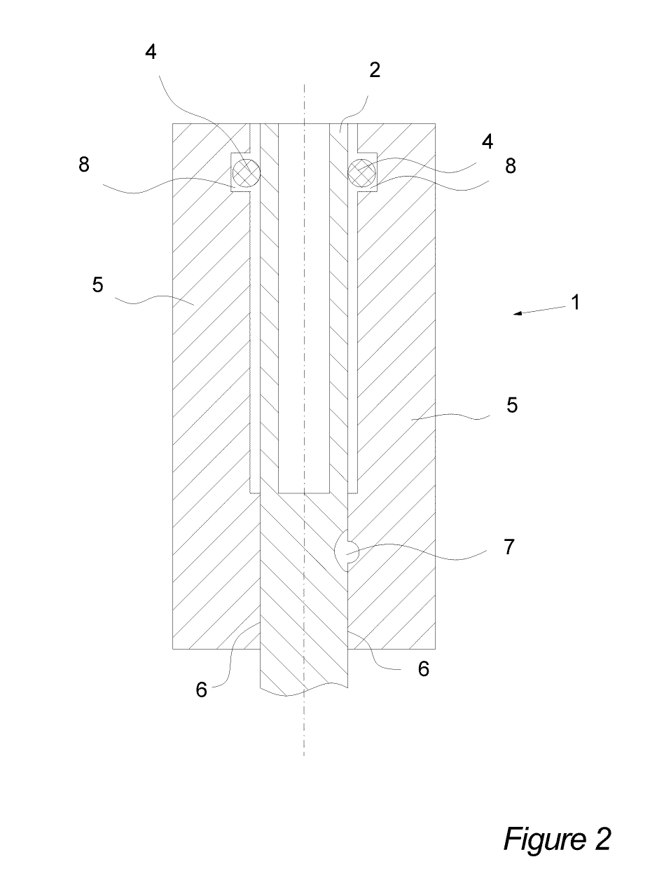

FIG. 2 illustrates a cross-section of an electrical connector 1 according to a preferred embodiment of the invention. The connector 1 comprises an outer shell 5 in relation to which a cylindrically shaped female contact member 2 is fixed by means of a press fit 6 between the outer shell 5 and the female contact member 2.

In order to further secure the female contact member 2 against rotation or longitudinal displacement relative to the outer shell 5, the female contact member 2 may be provided with one or more small knobs 7 on the outer surface of the part entering the press fit 6 with the outer shell 5. This part of the female contact member 2 may be fully solid as illustrated in the figure, or a part or the whole of it may be shaped as a cylindrical shell just like the upper part of the female contact member 2 shown in the figure.

The outer shell 5 is provided with a groove 8 surrounding the female contact member 2 near its open end for holding an O-ring 4. This groove ensures that the O-ring will not be displaced in a longitudinal direction relative to the outer shell 5 and the female contact member 2.

The O-ring 4 acts as a resilient contact pressure enhancing member applying an inward pressure to the outer surface of the cylindrical shell, thus assisting the inherent elasticity of the metal, from which the female contact member 2 is made, in ensuring a sufficient contact pressure when connected with a male contact member and in bringing back the cylindrical shell to its original shape after disconnection of the male and female contact members 2.

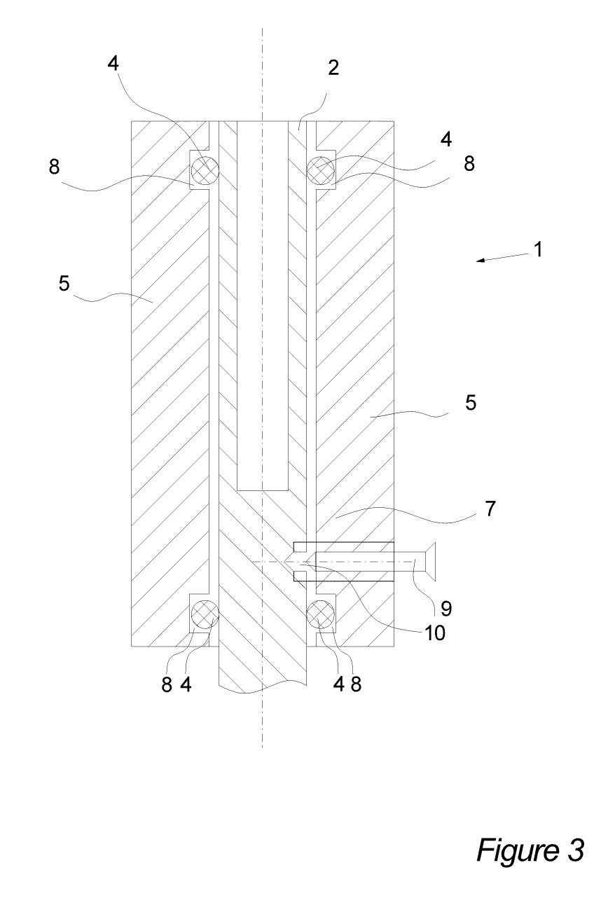

FIG. 3 illustrates an embodiment of the invention, in which the electrical connector 1 comprises two O-rings 4 placed at opposite ends of the female contact member 2. In this case there is no press fit 6 between the female contact member 2 and the outer shell 5, and the fixation of the former relative to the latter is obtained by means of a fixating screw 9 (or pin) going through the outer shell 5 and ending in a recess 10 in the female contact member 2 for preventing rotation or longitudinal displacement of the female contact member 2.

This embodiment, in which the female contact member 2 is almost entirely surrounded by air, enables for the use of air as the primary dielectric, thus reducing the dielectric absorption even with female contact members 2 made from soft materials having a high conductivity, such as gold, silver or copper. Obviously, the low dielectric absorption can also be obtained with female contact members 2 made from more usual, harder metals.

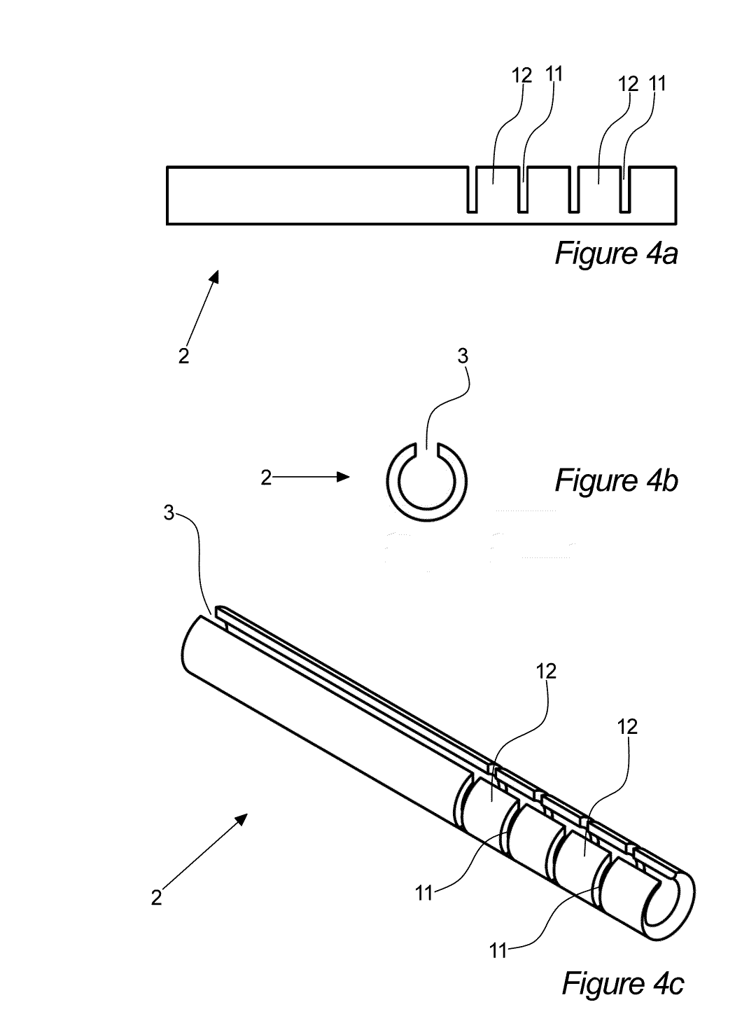

FIGS. 4a-4c illustrate another embodiment of a female contact member 2 according to the invention. FIGS. 4a and 4c show how a number of transverse slits 11 perpendicular to the longitudinal slit 3 divides a substantial part of the female contact member 2 into sub-elements 12.

If one or more O-rings (4, not shown in FIGS. 4a-4c) are placed around each of these sub-elements 12, a more or less constant inward/outward contact pressure can be obtained all along the part of the female contact member 2, which is divided into sub-elements 12. Furthermore, the division of the female contact member 2 into several sub-elements 12 allows for the creation of a higher number of pressure points, i.e. a higher number of positions to place O-rings 4, can be created along the female contact member 2, resulting in a higher overall contact pressure.

1. An electrical connector comprising:
a female contact member; and
at least one resilient contact pressure enhancing member;
wherein at least a part of the female contact member is formed as a cylindrical shell having at least one slit extending in a longitudinal direction from an open end of the cylindrical shell at least part of the way to an opposite end of the cylindrical shell;
wherein the at least one contact pressure enhancing member is arranged to apply an inward pressure to at least a part of an outer surface of the cylindrical shell;
wherein the at least one contact pressure enhancing member applies pressure to the outer surface of the shell from substantially all radial directions; and
wherein the at least one contact pressure enhancing member is an O-ring.

2. An electrical connector according to claim 1, wherein the cylindrical shell further comprises one or more transverse slits extending to one or both sides from the at least one slit extending in a longitudinal direction, each of the one or more transverse slits being perpendicular to the slit extending in a longitudinal direction from which it extends.

3. An electrical connector according to claim 1, wherein the cylindrical shell comprises one or more grooves, the dimensions of which are arranged to fit the dimensions of the at least one contact pressure enhancing member so as to keep the at least one contact pressure enhancing member in a substantially fixed position compared to the female contact member.

4. An electrical connector according to claim 1, wherein the female contact member is made from a soft metal of high conductivity and low elasticity, such as silver, copper or gold.

5. An electrical connector according to claim 1 further comprising an outer shell surrounding at least a part of the cylindrical shell.

6. An electrical connector according to claim 5, wherein the female contact member is held in position by at least two contact pressure enhancing members and otherwise substantially surrounded by air.

7. An electrical connector according to claim 5, wherein the outer shell comprises a groove, the dimensions of which are arranged to fit the dimensions of the at least one contact pressure enhancing member so as to keep the at least one contact pressure enhancing member in a substantially fixed position compared to the outer shell.

8. An electrical connector according to claim 5, wherein the outer shell is made from a hard material, such as aluminium, brass or plastic.

9. A method for enhancing contact pressure of a female contact member of an electrical connector, said method comprising the step of
arranging at least one contact pressure enhancing member to apply an inward pressure to at least a part of an outer surface of the female contact member, thus pressing at least a part of the female contact member towards a center of the female contact member, wherein the at least one contact pressure enhancing member is an O-ring.
